(19) United States
(12) Patent Application Publication
(10) Pub. No.: US 2007/0136454 A1
(43) Pub. Date: Jun. 14, 2007

(54) PERFORMANCE PROCUREMENT SYSTEM

(76) Inventors: Gregg N. Spiridellis, Santa Monica, CA (US); Evan N. Spiridellis, Santa Monica, CA (US)

Correspondence Address: INTELLECTUAL PROPERTY LAW OFFICES, 1901 S. BASCOM AVENUE, SUITE 660, CAMPBELL, CA, 95008, US

(21) Appl. No.: 11/548,643

(22) Filed: Oct. 11, 2006

Related U.S. Application Data
(60) Provisional application No. 60/596,655, filed on Oct. 11, 2005.

(51) Int. Cl. G06F 15/173

(52) U.S. Cl. 709/223

(57) ABSTRACT

A method for a sponsor to elicit submissions of performances to be prepared by multiple players. A digital media request (DMR) is posted for a digital media asset (DMA), where the DMR includes guidelines describing the performance and provides directions about a format that the performance should be embodied in as the DMA. At least one DMA is then received from each of the players. And one or more of the players is rewarded based on the acceptance of the respective DMAs by audience members in a global communications network like the Internet.

### CROSS-REFERENCE TO RELATED APPLICATIONS

This application claims the benefit of U.S. Provisional Application No. 60/596,655, filed Oct. 11, 2005, hereby incorporated by reference in its entirety.

### TECHNICAL FIELD

The present invention relates generally to publishing digital media in global communications networks, and more particularly to procuring instances of such digital media that meet specific subject matter guidelines.

### BACKGROUND ART

Of present interest is expressions, or performances as we will herein refer to both expressive works and expressive actions. People have always felt a deep desire to express themselves, as evidenced by prehistoric cave paintings and continuing to this day in many of the currently popular social networking web sites. Similarly, people apparently have always also felt a desire to experience expressions or performances. Excepting a few instances of prehistoric vandalism and the strong belief by some that critic is the world's third oldest profession, we can only presume that ancient cave paintings engendered audience feedback. In written history and especially today, however, we have ample proof that people want to experience performances.

The global communications network known as the Internet is profoundly changing our society in many ways. In particular, it is providing new forums for performances and their consumption. Many Internet services today invite visitors to submit media content. But often these have no guidelines at all about subject matter, or have guidelines that are ignored by all. Beyond token subject matter guidelines, Internet services today do very little to entice submission of quality performances, to determine which performances have quality, and to provide their audiences access to performances based on quality. It follows that what is available in such services today, even when within subject matter guidelines, is not choreographed, scripted, or directed. It is also usually minimally reviewed. It therefore is not surprising that such media content has limited ability to initially draw audience attention, and that it does not hold audience attention for long.

With respect to audience expectations being met and audience satisfaction, most services on the Internet have yet to equal other forums, like print media, radio, and television. The exceptions to this are, of course, services that present media content from traditional forums like print media, radio, and television. This is especially unfortunate because it does not take advantage of the strengths of the Internet, such as its vastness, its dynamic nature, and especially its near trivial barriers to entry. Accordingly, what is need here is an improved system to procure performances, and optionally to rank and present those performances on the current Internet and on and global communications network that nay supersede it.

### DISCLOSURE OF INVENTION

Accordingly, it is an object of the present invention to provide a performance procurement system.

Briefly, one preferred embodiment of the present invention is a method for a sponsor to elicit submissions of performances to be prepared by a plurality of players. A digital media request (DMR) is posted for a digital media asset (DMA), where the DMR includes guidelines describing the performance and directions about a format that the performance should be embodied in as the DMA. At least one DMA is then received from each of the players. And one or more of the players is rewarded based on acceptance of respective of the DMAs by audience members in a global communications network.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE DRAWINGS

The purposes and advantages of the present invention will be apparent from the following detailed description in conjunction with the appended figures of drawings in which:

FIG. 1 is a stylized block diagram schematically depicting the major elements of a performance procurement system in accord with the present invention; and

FIG. 2a-c are flow charts depicting the major steps in a process used by a performance procurement system, such as that in FIG. 1.

In the various figures of the drawings, like references are used to denote like or similar elements or steps.

### BEST MODE FOR CARRYING OUT THE INVENTION

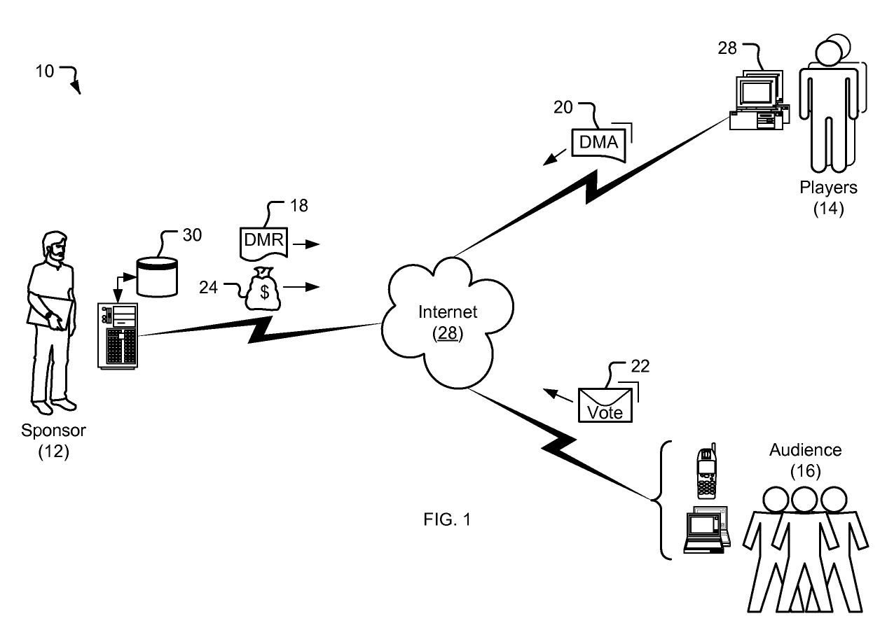

A preferred embodiment of the present invention is a performance procurement system. As illustrated in the various drawings herein, and particularly in the view of FIG. 1, preferred embodiments of the invention are depicted by the general reference character 10.

FIG. 1 is a stylized block diagram schematically depicting the major elements of a performance procurement system 10 in accord with the present invention. The parties using the performance procurement system 10 include a sponsor 12, players 14, and an audience 16. The major elements exchanged within the system include a request for a performance, termed herein a “digital media request” (DMR 18); a submission of a performance, termed herein a “digital media asset” (DMA 20); votes 22; and rewards 24.

The specific nature of a “performance” versus the broad/general nature of media requests in prior art services is one key distinction of the performance procurement system 10. Prior art services invite visitors to submit media content based on broad/general subject matter (e.g. pictures or videos of your pets) and are not choreographed, scripted, or directed. In contrast, the inventive performance procurement system 10 here is very directed, usually requiring a player 14 to take affirmative action based on what a DMR 18 specifies, to set-up or perform in some specific manner and then capture that performance in a DMA 20, usually in a specified media format. The chance of a player already having a media asset that could be contributed to a prior art service is very high while the chance of having a DMA 20 including a performance specified in a DMR 18 is therefore small.

By knowing the specific nature of the content being submitted, the sponsor 12 can structure the presentation of the DMAs 20 to an audience 16 in a manner that better maximizes the entertainment value of the submissions relative to prior art schemes. As a result, the members of the audience 16 spend more time interacting with and diligently voting on media submitted under defined performance guidelines than they would with media submitted under prior art.

As represented in FIG. 1, the parties employ various media-capture and communications devices to handle the other elements, and it is anticipated that most of these devices will be computerized (and they are therefore collectively represented iconically as a computer 26 in FIG. 1). Without limitation, some typical media-capture devices may be film-process cameras and scanners, for artistically crafted images or still-photograph subject matter; or such devices may be camcorders or digital cameras or camera phones, for still as well as animated or live-motion subject matter. Alternately, the capture devices can be analog or digital recorders or signal constructing software, for instance, when the performances are or include audible subject matter. Typical communications devices can be server and workstation terminals, personal computers (PCs), cellular telephones, personal digital apparatus (PDAs), etc. These all inter-communicate via a global communication network, such as the Internet 28, as shown in FIG. 1.

In the performance procurement system 10, the sponsor 12 is a party ostensibly hosting a game or contest for the benefit of the players 14 and audience 16, but more truly seeking to obtain performances (DMAs 20) from the players 14 and rankings of those by the audience 16. One ultimate motivation for the sponsor 12 may be to procure the DMAs 20 for use within a larger production that it is crafting, say, in a webpage, photo-collage, soundtrack, or video. Alternately, the motivation of the sponsor 12 may be to amuse either or both the players 14 and audience 16 sufficiently that they are exposed to advertising on a website used for communicating any or all of the DMR 18, DMAs 20, and votes 22 or to charge a premium for members of the audience 16 to participate in a media-related activity. Yet another motivation of the sponsor 12 may be to identify talented individuals from within the large body of players 14 and also from within the audience 16.

The players 14 are parties that submit candidate performances (DMAs 20), typically, but not necessarily, after first also performing and capturing them. The players 14 may have any of various motivations to participate. For some, personal challenge and satisfaction is a contributing or total motivation, and for others, recognition by the audience 16 may be the motivation. Belonging to a particular community, especially one founded on discovering and acknowledging creativity is by itself a strong motivation. For still others, some formal reward 24 from the sponsor 12 can be the motivation. It should be noted and keep in mind, however, that the rewards 24 here need not have any appreciable monetary value or take tangible form. For example, players 14 may elect to participate for attribution as the source of a particular DMA 20 or for public acknowledgement of highly ranked DMAs 20. Those players 14 whose DMAs 20 are used can also be rewarded by being cited in the “credits” of productions by the sponsor 12. Alternately, a player 14 may participate because the sponsor 12 is providing prize tokens or participation premiums (i.e., rewards 24), say, ones redeemable for play time in an online game or as payment to submit DMAs 20 in future media activities. Or a player 14 may participate in the hope of winning a complimentary copy of a media-based production including their DMA 20 or even for a money payment or prize with substantial monetary value from the sponsor 12.

The audience 16 ranks the performances (DMAs 20) by casting the votes 22, either overtly or impliedly. For example, members of the audience 16 might cast a vote 22 overtly by operating one or more voting controls embedded in a web page, say, by clicking Like/Dislike buttons or by selecting a value in a Rank-One-To-Ten type web-control. More subtly, members of the audience 16 can cast votes 22 impliedly with respect to their interaction with the content of the DMAs 20. This can be, for instance, by monitoring (i) how many members of the audience 16 click on one DMA 20 versus another, (ii) how much of a DMA 20 the members of the audience 16 elect to perceive (e.g., how much time they spend gazing at a picture, watching a video or listening to an audio track), (iii) how many members of the audience 16 take action to share the content with other people, (iv) how many members of the audience 16 tag the DMAs 20 in a manner that enables easy access to their content in the future (e.g., as a “favorite”), (v) how many members of the audience 16 take action to opt-out of seeing content of DMAs 20 submitted by the author of a particular DMA 20 in the future, and (vi) how many members of the audience 16 elect to respond to the submission with a related submission. The aforementioned are listed for the purpose of example and many other similar metrics can be put in place to accomplish the objective of identifying the best content in the performance procurement system 10. The technical issues related to noting and measuring such actions can be significant, but are generally just exercises in programming and some particular examples are discussed presently.

The audience 16 can also have various motivations. In many cases, personal amusement will be sufficient. In other cases, say, ones where it takes appreciable time to review a DMA 20 or where the casting the votes 22 involves providing affirmative responses about multiple ranking criteria, members of the audience 16 can also be motivated by rewards 24 from the sponsor 12. For example, members of the audience 16 might win randomly awarded prize tokens or cash prizes, or they can be “paid” with tokens or payments based on how many DMAs 20 they review or how long they spend reviewing them. There can also be scoring mechanisms that convey accolades upon a member of the audience 16 who consistently identifies the highest quality DMAs 20 in the performance procurement system 10 (e.g., a notation on a user profile page that designates the person a “Super Talent Scout”). Another example, is that by casing votes 22 for DMAs 20 the likes and dislikes of a particular member of the audience 16 can be ascertained and the sponsor 12 can then match that person with other members of the audience 16 having similar tastes or sensibilities, and present content that he or she is most likely to enjoy, thereby elevating the signal-to-noise ratio and increasing the entertainment value delivered by the performance procurement system 10.

One competitive variation of motivation for the audience 16 that is contemplated by the present inventors is to reward the members of the audience 16 based what portion of their votes were “right” or “wrong” for many DMAs 20. For instance, if Jane's votes 22 statistically correlate with the picks by the overall audience 16 more than the votes 22 of others do, Jane can be provided a reward 24 in the form of public acknowledgement of this or some more substantial prize. Similarly, if Joe's votes 22 show that he rarely is part of the “herd,” this can also be acknowledged with a reward 24. Joe's picks might have value because they are unpredictable, or because a vote 22 the opposite of Joe's is an even better predictive than one the same as Jane's. As already noted, one motivation for a sponsor 12 can be to find and use valuable people like these to identify the best DMAs 20 in the performance procurement system 10.

Members of the audience 16 might potentially include players 14 casing votes 22 for their own DMAs 20 or for ones submitted by others. Optionally then, say, in the interest of minimizing bias, programmatic means can be applied to suppress inclusion of players 14 in the audience 16.

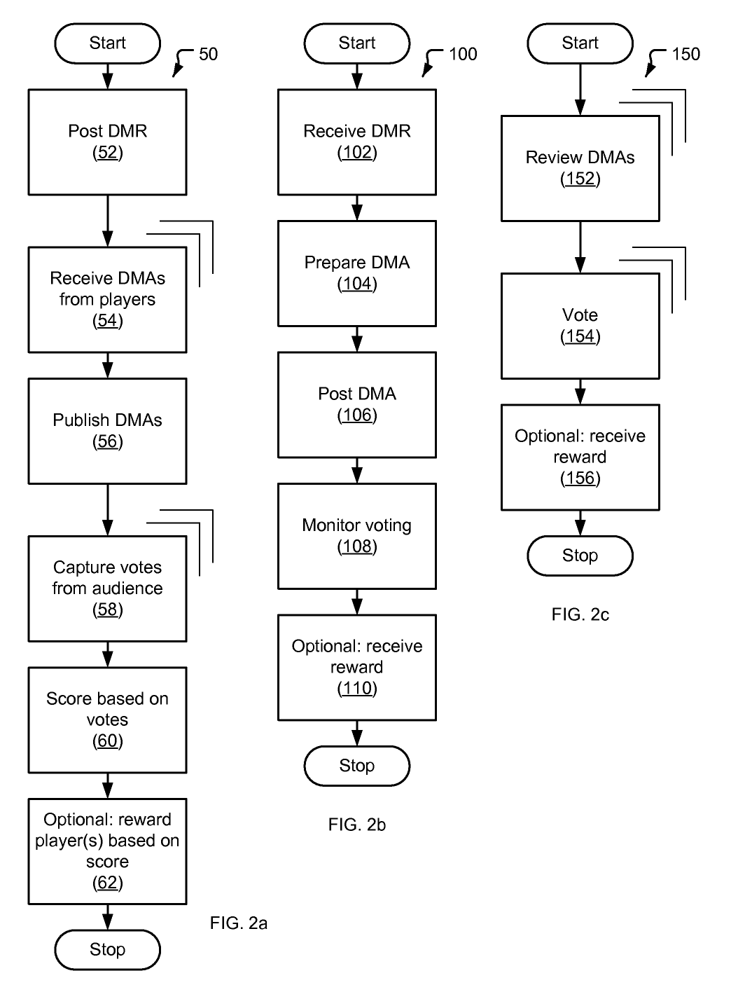

FIG. 2a is a flow chart depicting, from the perspective of a sponsor 12, the major steps in a process 50 used by a performance procurement system 10 such as the embodiment in FIG. 1. The process 50 starts in a step 52 when the sponsor 12 posts a DMR 18, that is, when it posts a request for a performance.

Typically, but not necessarily, the sponsor 12 will post the DMR 18 on a website where a large range of potential players 14 can see it. Alternately, direct requests can be sent out by postal mail, by e-mail, as instant messages, or by still other means. These approaches can be used for particular types of DMAs 20, where the extra effort they entail will be justified, or when contact information for a set of potential players 14 is available (e.g., for a set of past winners).

In a step 54 the sponsor 12 will then receive back DMAs 20, that is, digital submissions of performances. In general, it is hoped that many DMAs 20 will be received, and the sponsor 12 can elect to perform this step without limit or subject to either a time or number received limit. The DMAs 20 are received at a website that is crafted to permit submissions of messages with attachments. This usually will be the same website where the DMR 18 was posted, albeit perhaps using a different webpage. Theoretically, however, there is no technical reason that this cannot be at an entirely different website. As the DMAs 20 are received they typically will be stored, and FIG. 1 stylistically depicts a database 30 for this.

A DMR 18 can include guidelines with varying specificity for what is suitable. As a matter of design choice, the performance procurement system 10 can perform automated filtering of the DMAs 20. For example, if a DMR 18 specifies a video, any submissions in TIFF, GIF, or JPEG formats can be rejected, since these are still image formats. Such rejection can be by simply ignoring the DMA 20 or by affirmatively advising the player 14 that their submission is non-compliant. Alternately, say, if the DMR 18 specifies that submissions be in the form of an MP3-type sound file and a player 14 submits a MIDI-type sound file, this near-compliant submission can be converted automatically and then accepted.

Additionally, since it is highly likely that some players 14 will try to “flood” the performance procurement system 10 with multiple submissions of different DMAs 20 or with resubmissions of the same DMA 20, filtering can be used to suppress such attempts. For instance, DMAs 20 can be digitally compared and origin information for the players 14 (e.g., IP addresses or patterns based on such) can also be noted and analyzed. The players 14 and members of the audience 16 can also be required to create user accounts, with automated-registration suppression measures employed if desired. The performance procurement system 10 can explicitly limit the number of DMAs 20 submitted per player 14 and per DMR 18, or indirectly do so by charging for submission of each DMA 20.

Any players 14 who are particularly egregious “cheats” can be masked out, perhaps along with being issued a warning that they will not be eligible for any future rewards if they persist or somehow do manage to get another DMA 20 accepted in the present contest. Preventing cheating is important to all of the parties here. The players 14 need to know that their DMAs 20 have a fair chance for unbiased review. The audience 16 does not want to waste time on duplicate or poor quality DMAs 20. And the sponsors 12 want quality DMAs 20, to correctly identify talented players 14 and members of the audience 16, and to keep these happy so they stay active participants.

In a step 56 the sponsor 12 next publishes the DMAs 20. This can include an identification of the source player 14 or merely publication of the performance content of the DMA 20. As a matter of design, this step can be closely integrated with receiving the DMAs 20, wherein a DMA 20 is published almost automatically and instantaneously upon receipt. Alternately, this can be only after some degree of review by the sponsor 12, to ensure that what is published for the audience 16 will meet their expectations and merit their votes 22.

The specific nature of a “performance” in the inventive performance procurement system 10, versus the broad/general nature of media requests in prior art services, gives the sponsor 12 the ability to structure the presentation of submitted DMAs 20 in a manner that maximizes their entertainment value. The foreknowledge that DMAs 20 submitted can adhere to strict guidelines, allows the sponsor 12 to treat them as components that fit into an overall content presentation system that is architected to entice the members of the audience 16 to spend more time interacting with and diligently casting votes 22 on the submitted DMAs 20 than they would otherwise in the less structured environments.

In a step 58 the sponsor 12 will then receive back votes 22, that is, affirmations of some action by members of the audience 16 with respect to one or more respective DMAs 20. In general, it is hoped that many votes 22 will be received, and the sponsor 12 can perform this step without limit or subject to either a time or number received limit. This may be out of desire to collect totals of the votes 22 that are statistically significant or simply as a matter of choice.

As noted in passing above, the nature of a vote 22 can vary considerably. In simple form, recording votes 22 as being cast can simply entail logging click-through rates. That is, the number of times that a DMA 20 is clicked relative to the number of times that it is downloaded from a server becomes a metric for ranking its quality. This approach is already widely used today to measure exposure to Internet advertising. In a somewhat more sophisticated form, this kind of casting of votes 22 can include requiring that a viewing member of the audience 16 click on a rating for one DMA 20 before they are served and permitted to review another. Of course, one form of implied casting of votes 22 is to have the members of the audience 16 selectively click to perceive the content of one DMA 20 over that of other choices that are presented for selection. The time spent in review can also be measured and used to determined votes 22, albeit subject to the limitations inherent in webpage presentation mechanisms and in remote applet operation. For example, downloading a photograph (i.e., a particular type of DMA 20) and observing a five second delay before another is download can constitute a vote 22 (whereas a delay of less than one second might not be counted as a valid vote 22). Similarly, downloading a two-minute video (i.e., another particular type of DMA 20) and observing a two to five minute delay before downloading something else may constitute a vote 22 (whereas clicking something else within 10 seconds might not be counted as a valid vote 22). The downloading of a photograph followed by downloading another an hour later may also be a case that should not be counted as a vote 22, since there is no way to implicitly gage from this what portion of the time was spent contemplating the photograph, verses, for instance, a member of the audience 16 taking a break to eat dinner.

In a step 60, in what is probably the most straightforward step in the whole process 50 here, the sponsor 12 scores the various DMAs 20 based on the votes 22 it receives and considers valid. The sponsor 12 can record the votes 22 on either a running or a milestone basis, presuming that it even publishes the totals of votes 22. In general it is anticipated that the votes 22 received will be reported to the players 14 and the audience 16, typically by publication on the same website or websites used for posting the DMR 18 and publishing the DMAs 20. But this is also not a requirement, and there is no reason that the sponsor 12 ever report about the votes 22. Of course, the sponsor 12 often will want to do so to keep the players 14 and the audience 16 interested and motivated enough to return and use the performance procurement system 10 in the future.

In an optional step 62, at the end of the process 50 shown here, although the games or contests here can be perpetual or ongoing and thus have no true set end, there potentially are the rewards 24. For some players 14 the ability to have participated is already enough of a reward 24. For others, to have their work published to the audience 16 is enough, especially if they also receive attribution or accolades. For others, a more substantial form of a reward 24 can ensue. Numerous examples have already been noted. Optionally, the sponsor 12 can provide rewards 24 to some portion of the audience 16.

FIG. 2b is a flow chart depicting, from the perspective of a player 14, the major steps in a process 100 used by a performance procurement system 10 such as the embodiment in FIG. 1. The process 100 starts in a step 102 when the player 14 “receives” a DMR 18, that is, becomes aware of a request for a performance.

Typically, but not necessarily, the player 14 will visit a website of the sponsor 12 to receive a DMR 18. Alternately, say, for players 14 whom one or more sponsors 12 have identified as being potential future players 14, direct requests can be received by postal mail, e-mail, as an instant messages, or by still other means.

In a step 104, responsive to the DMR 18, the player 14 embodies a performance into a DMA 20. This can involve personally posing or acting out the performance, if its nature requires such, or producing or directing the performance, if its nature requires that. Alternately, the player 14 may artistically construct the performance, say, by building and editing a scene in an image editor program or a musical track in a synthesizer program. If not inherent in the nature of the performance, or if conversion is needed, the performance is then captured in final form into the DMA 20.

In a step 106 the player 14 posts the DMA 20. The details of this have already been discussed, with those details controlled by the DMR 18 and the sponsor 12.

In a step 108 the player 14 will then, optionally but presumably almost always, monitor the votes 22 cast by the audience 16 or wait for some form of feedback from the sponsor 12. The details of this have also already been discussed, and are largely controlled by the sponsor 12.

And in a step 110, if the work of a player 14 merits this based on its content, or based on some factor such as random grant or diligence, the player 14 can receive a reward 24. As noted elsewhere, for many players 14 publication, attribution, or accolades for their performance will already be some measure of reward 24, so this stage is where one or more optional rewards 24 from the sponsor 12 can be obtained.

FIG. 2c is a flow chart depicting, from the perspective of an audience 16, the major steps in a process 150 used by a performance procurement system 10 such as the embodiment in FIG. 1. As already discussed, the sponsor 12 will have created a venue and players 14 will have filled that venue with performances (i.e., with DMAs 20). Now the audience 16 visits that venue.

Typically, the sponsor 12 will publish the DMAs 20 on a website where the audience 16 can easily find them. As an initial way for the audience 16 to become aware of such a site, however, they can be enticed there by advertising, favorable reviews, or direct invitations. The mechanisms used for this can be any, but generally will be conventional.

Thus, in a step 152 the audience 16 arrives where the sponsor 12 has published the DMAs 20, and reviews them in whatever manner the sponsor 12 has provided for and use whatever resources the members of the audience 16 have available for this. For example, if a particular DMA 20 is a WMV file, one member of the audience 16 might view it directly in streaming manner within a player-window in their web-browser. Another member of the audience 16, however, might download the entire WMV file and then play it in a suitable local player-program. The latter approach is not preferred, and many embodiments of the invention may not provide for it, but it is still manageable. For instance, a “library” type mechanism can be employed for recording the votes 22, wherein a member of the audience 16 “checks out” a DMA 20 and has to return and cast a vote 22 on it to “check it back In” before they can access other DMAs 20.

In a step 154, having reviewed the DMA 20, or implicit in their doing so, the members of the audience 16 cast votes 22 on it. As discussed, this is also controlled largely by the sponsor 12, and the voting need not even entail affirmative actions by members of the audience 16.

Optionally, in a step 156 members of the audience 16 can also receive rewards 24. Presumably, being exposed to the DMAs 20 alone will be one form of reward 24, but the sponsor 12 may optionally provide other forms of rewards 24. For instance, based on random selection of members of the audience 16 or based on the total quantity or duration of the DMAs 20 they review. In particular, the nature of the rewards 24 that are provided here can be important. Since the sponsor 12 can collect data to form a good idea of what genres are enjoyed by specific members of the audience 16, the sponsor 12 can tailor the rewards 24 accordingly. For instance, if the sponsor 12 determines that a particular member of the audience 16 likes adult alternative music it can give that member credits for specific music title downloads at an on-line music vendor. Since the sponsor 12 will have “qualified” the preferences of this member of the audience 16, and since it may full well be first introducing them to the music vendor's website and providing them with the opportunity to learn about that vendor's other wares, a savvy sponsor 12 can likely persuade the vendor to provide them with a supply of music download credits for free to use as the rewards 24.

While various embodiments have been described above, it should be understood that they have been presented by way of example only, and that the breadth and scope of the invention should not be limited by any of the above described exemplary embodiments, but should instead be defined only in accordance with the following claims and their equivalents.

1. A method for a sponsor to elicit submissions of performances to be prepared by a plurality of players, the method comprising:
posting a digital media request (DMR) for a digital media asset (DMA), wherein said DMR includes guidelines describing the performance and directions about a format that the performance should be embodied in as said DMA;
receiving from each of the players at least one said DMA; and
rewarding one or more of said players based on acceptance of respective said DMAs by audience members in a global communications network.

2. The method of claim 1, wherein:
said posting includes placing said DMR on said global communications network to be seen there by the plurality of players.

3. The method of claim 1, wherein:
said receiving includes accepting said DMAs as attachments to messages to a website in said global communications network.

4. The method of claim 1, wherein:
said receiving includes at least one of rendering compliant a said DMA that is near-compliant with said DMR, rejecting a said DMA that is non-compliant with said DMR, and rejecting a said DMA that is not unique with respect to another said DMA.

5. The method of claim 1, wherein:
said receiving includes limiting acceptance of a said DMA based on at least one of a time within which a said DMA will be received, a total quantity of said DMAs that will be received, a per-player quantity of said DMAs that will be received, a per-player quantity of said DMAs that will be received for a specific DMR, and charging for submission of each said DMA.

6. The method of claim 1, further comprising:
prior to said rewarding, publishing said DMAs from the plurality of players to said audience members via said global communications network, thereby permitting said audience members to review the performances embodied within said DMAs.

7. The method of claim 6, further comprising:
prior to said publishing, packaging the performances received in said DMAs in a structured presentation to enhance the entertainment value of said DMAs.

8. The method of claim 7, wherein:
said packaging includes one of grouping the performances in said DMAs based on subject matter and combining the performances in said DMAs into a larger performance.

9. The method of claim 1, further comprising:
prior to said rewarding, scoring each of said DMAs to determine said acceptance based on votes cast by said audience members about respective of the performances embodied within said DMAs.

10. The method of claim 9, wherein:
said scoring includes limiting acceptance of a said vote based on at least one of a time within which a said vote will be accepted, a total quantity of said votes that will be accepted, a per-member quantity of said votes that will be accepted, and charging for submission of each said vote.

11. The method of claim 9, wherein:
a said vote is overtly cast by a said audience member operating one or more voting controls embedded in a web page.

12. The method of claim 9, wherein:
a said vote is impliedly cast by an interaction of a said audience member with content of the performance.

13. The method of claim 12, wherein:
said interaction includes at least one of logging a click-through rate, measuring how much of a said DMA a said member elects to perceive, counting how many said members click on one said DMA versus others, counting how many said members act to share the performance in a said DMA with others, counting how many said members take action to opt-out of seeing said DMAs in the future that are related to a current said DMA, counting how many said members elect to respond to the performance in a said DMA with a related performance, and counting how many said members tag a said DMA to enable future access.

14. A computerized system for a sponsor to elicit submissions of performances to be prepared by a plurality of players, comprising:
a logic that posts a digital media request (DMR) for a digital media asset (DMA), wherein said DMR includes guidelines describing the performance and directions about a format that the performance should be embodied in as said DMA;
a logic that receives from each of the players at least one said DMA; and
a logic that rewards one or more of said players based on acceptance of respective said DMAs by audience members in a global communications network.

15. The system of claim 14, wherein:
said logic that posts said DMR posts it on said global communications network to be seen there by the plurality of players.

16. The system of claim 14, wherein:
said logic that receives said DMAs receives them as attachments to messages to a website in said global communications network.

17. The system of claim 14, wherein:
said logic that receives said DMAs performs at least one of rendering compliant a said DMA that is near-compliant with said DMR, rejecting a said DMA that is non-compliant with said DMR, and rejecting a said DMA that is not unique with respect to another said DMA.

18. The system of claim 14, wherein:
said logic that receives said DMAs limits acceptance based on at least one of a time within which a said DMA will be received, a total quantity of said DMAs that will be received, a per-player quantity of said DMAs that will be received, a per-player quantity of said DMAs that will be received for a specific DMR, and charging for submission of each said DMA.

19. The system of claim 14, further comprising:
a logic that publishes said DMAs from the plurality of players to said audience members via said global communications network, thereby permitting said audience members to review the performances embodied within said DMAs.

20. The system of claim 19, wherein
said logic that publishes said DMAs packages the performances received in them in a structured presentation to enhance their entertainment value.

21. The system of claim 20, further comprising:
said logic that publishes said DMAs packages them by one of grouping the performances in said DMAs based on subject matter and combining the performances in said DMAs into a larger performance.

22. The system of claim 14, further comprising:
a logic that scores each of said DMAs to determine said acceptance based on votes cast by said audience members about respective of the performances embodied within said DMAs.

23. The system of claim 22, wherein:
said logic that scores each of said DMAs limits acceptance of a said vote based on at least one of a time within which a said vote will be accepted, a total quantity of said votes that will be accepted, a per-member quantity of said votes that will be accepted, and charging for submission of each said vote.

24. The system of claim 22, wherein:
said logic that scores each of said DMAs monitors whether a said vote is overtly cast by a said audience member operating one or more voting controls embedded in a web page.

25. The system of claim 22, wherein:
said logic that scores each of said DMAs monitors whether a said vote is impliedly cast by an interaction of a said audience member with content of the performance.

26. The system of claim 25, wherein:
said interaction includes at least one of logging a click-through rate, measuring how much of a said DMA a said member elects to perceive, counting how many said members click on one said DMA versus others, counting how many said members act to share the performance in a said DMA with others, counting how many said members take action to opt-out of seeing said DMAs in the future that are related to a current said DMA, counting how many said members elect to respond to the performance in a said DMA with a related performance, and counting how many said members tag a said DMA to enable future access.
